(19) United States
(12) Patent Application Publication
(10) Pub. No.: US 2011/0291784 A1
(43) Pub. Date: Dec. 1, 2011

(54) ELECTRONIC COMPONENT

(75) Inventor: Yoichi NAKATSUJI, Kyoto-fu (JP)

(73) Assignee: MURATA MANUFACTURING CO., LTD., Kyoto-fu (JP)

(21) Appl. No.: 13/207,053

(22) Filed: Aug. 10, 2011

Related U.S. Application Data
(63) Continuation of application No. PCT/JP2009/071116, filed on Dec. 18, 2009.

(30) Foreign Application Priority Data
Feb. 10, 2009 (JP) 2009-028690

(51) Int. Cl. H01F 27/29

(52) U.S. Cl. 336/192

(57) ABSTRACT

An electronic component capable of adjusting the number of turns of a coil without preparing multiple kinds of inner conductors to be positioned at an end of the layer direction is composed of a multilayer body having multiple laminated magnetic layers. A spiral coil includes inner conductors and via-hole conductors connected to each other. Each of the inner conductors has a length of one turn. Both ends of each of the inner conductors are over points A and B. The inner conductor provided at the most negative side in the z-axis direction branches at one end so as to be over the points A and B.

### CROSS REFERENCE TO RELATED APPLICATIONS

The present application claims priority to Japanese Patent Application No. 2009-028690 filed Feb. 10, 2009, and International Patent Application No. PCT/JP2009/071116 filed Dec. 18, 2009, the entire contents of each of these applications being incorporated herein by reference in their entirety.

### FIELD OF THE INVENTION

The present disclosure relates to electronic components and, more particularly, to an electronic component in which a coil is included in a multilayer body.

### BACKGROUND

An example of a known multilayer inductor disclosed in Japanese Unexamined Patent Application Publication No. 2001-44037. FIG. 7 is an exploded perspective view of a multilayer body 111 of the multilayer inductor.

The multilayer body 111 includes magnetic layers 112a to 112l, inner conductors 114a to 114f, and via-hole conductors B1 to B5. The magnetic layers 112a to 112l are insulating layers that are disposed in the order from the upper side to the lower side in the layer direction.

The inner conductor 114a is provided on the magnetic layer 112d and one end of the inner conductor 114a extends to the right side face of the multilayer body 111. The inner conductors 114b to 114e make loops each having a length of one turn on the magnetic layers 112e to 112h, respectively. The inner conductors 114b and 114d have the same shape and the inner conductors 114c and 114e have the same shape. In other words, the inner conductors 114b and 114d and the inner conductors 114c and 114e having the two kinds of shapes are alternately arranged. The inner conductor 114f is provided on the magnetic layer 112i and one end of the inner conductor 114f extends to the left side face of the multilayer body 111.

The via-hole conductor B1 connects the inner conductor 114a with the inner conductor 114b, the via-hole conductor B2 connects the inner conductor 114b with the inner conductor 114c, the via-hole conductor B3 connects the inner conductor 114c with the inner conductor 114d, the via-hole conductor B4 connects the inner conductor 114d with the inner conductor 114e, and the via-hole conductor B5 connects the inner conductor 114e with the inner conductor 114f, thereby forming a coil L that spirally circles in the multilayer body 111. In the multilayer inductor in FIG. 7, a magnetic layer 112 having an inner conductor 114 provided thereon can be placed between, for example, the magnetic layer 112h and the magnetic layer 112i to adjust the number of turns of the spiral coil L in units of one turn.

However, according to the multilayer inductor described in Japanese Unexamined Patent Application Publication No. 2001-44037, it is necessary to change the shape of the inner conductor 114f in accordance with the shape of the inner conductor 114 placed between the magnetic layer 112h and the magnetic layer 112i in the multilayer inductor.

More specifically, the magnetic layer 112 having the inner conductor 114 of the same shape as that of the inner conductors 114b and 114d provided thereon may be placed between the magnetic layer 112h and the magnetic layer 112i in order to increase the number of turns of the spiral coil L by one turn in the multilayer body 111 in the state shown in FIG. 7. However, since the shape of the inner conductors 114b and 114d is different from that of the inner conductor 114e, it is not possible to connect the inner conductor 114 having the same shape as that of the inner conductors 114b and 114d with the inner conductor 114f via a via-hole conductor. Accordingly, it is necessary to redesign the inner conductor 114f to have a shape allowing connection with the inner conductor 114 having the same shape as that of the inner conductors 114b and 114d.

In other words, it is necessary to prepare the inner conductors 114f having two kinds of shapes in order to adjust the number of turns of the spiral coil L in units of one turn in the multilayer inductor disclosed in Japanese Unexamined Patent Application Publication No. 2001-44037.

### SUMMARY

a. Embodiments of the present disclosure provide an electronic component capable of adjusting the number of turns of a coil without preparing multiple kinds of inner conductors to be positioned at an end of the layer direction.

b. In an exemplary embodiment of the present disclosure, an electronic component is a multilayer body including a plurality of insulating layers that are laminated; an outer electrode provided on a surface of the multilayer body; and a coil included in the multilayer body. The coil includes a first coil conductor that circles in a certain direction from a first point to a second point in a plan view from a layer direction; a second coil conductor that circles in the certain direction from the second point to the first point in a plan view from the layer direction; a first via-hole conductor connected to the first point of the first coil conductor; a second via-hole conductor connected to the second point of the second coil conductor; and an end conductor that is over the first point and the second point and that is electrically connected to the outer electrode in a plan view from the layer direction. The first coil conductor, the first via-hole conductor, the second coil conductor, and the second via-hole conductor are alternatively arranged in the layer direction in a state in which the first coil conductor, the first via-hole conductor, the second coil conductor, and the second via-hole conductor are electrically connected to each other. The end conductor is provided at an upper side or a lower side of the layer direction, compared with the first coil conductor and the second coil conductor, and is electrically connected to the adjacent first coil conductor or second coil conductor.

According to the embodiment of the present disclosure, it is possible to adjust the number of turns of a coil without preparing multiple kinds of inner conductors to be positioned at an end of the layer direction.

Other features, elements, characteristics and advantages of the present disclosure will become more apparent from the following detailed description of preferred embodiments of the present disclosure with reference to the attached drawings.

### BRIEF DESCRIPTION OF DRAWINGS

FIG. 1 is an external perspective view of a multilayer inductor.

FIG. 2 is an exploded perspective view of a multilayer body of the multilayer inductor in FIG. 1.

FIG. 3 is an exploded perspective view of the multilayer body of the multilayer inductor in FIG. 1.

FIG. 4(a) is a plan view of an inner conductor according to a first modification from the positive side in the z-axis direction.

FIG. 4(b) is a plan view of an inner conductor according to a second modification from the positive side in the z-axis direction.

FIG. 5 is an exploded perspective view of a multilayer body of a multilayer inductor according to another embodiment.

FIG. 6 is a plan view of an inner conductor according to a modification from the positive side in the z-axis direction.

FIG. 7 is an exploded perspective view of a multilayer body of a multilayer inductor in related art.

A multilayer inductor, which is an electronic component according to an embodiment of the present disclosure, will now be described with reference to the drawings.

### DETAILED DESCRIPTION

### Structure of Multilayer Inductor

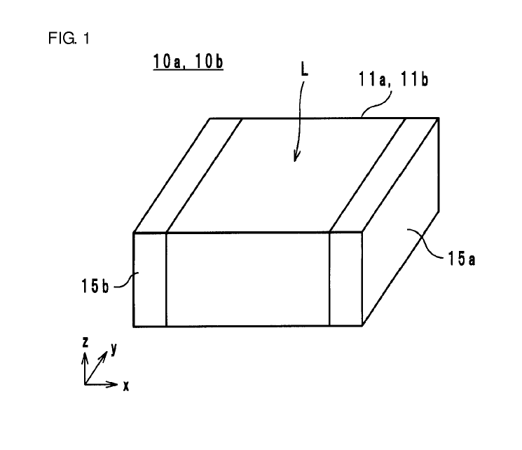

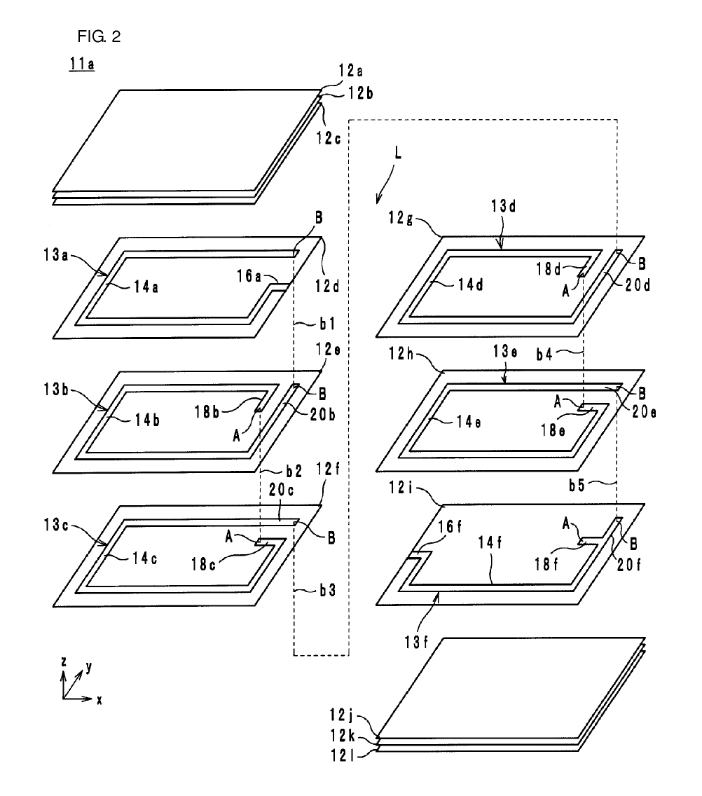

FIG. 1 is an external perspective view of each of multilayer inductors 10a and 10b. FIG. 2 is an exploded perspective view of a multilayer body 11a of the multilayer inductor 10a. The layer direction of the multilayer inductor 10a is defined as the z-axis direction, the direction along the longer sides of the multilayer inductor 10a is defined as the x-axis direction, and the direction along the narrower sides of the multilayer inductor 10a is defined as the y-axis direction.

The multilayer inductor 10a includes the rectangular parallelepiped multilayer body 11a and two outer electrodes 15a and 15b formed on the side faces (surfaces) of the multilayer body 11a, which are positioned at both ends of the x-axis direction, as shown in FIG. 1.

The multilayer body 11a is formed by laminating magnetic layers 12a to 12l and includes a spiral coil L, as shown in FIG. 2. The magnetic layers 12a to 12l are multiple rectangular insulating layers made of magnetic ferrite (for example, Ni—Zn—Cu ferrite or Ni—Zn ferrite). Points A and B are defined on the magnetic layers 12a to 12l. Alphabet characters are appended to reference numerals when the magnetic layers 12a to 12l are individually specified, and the alphabet characters are omitted from the reference numerals when the magnetic layers 12a to 12l are collectively referred to hereinafter.

The spiral coil L includes inner conductors 13a to 13f and via-hole conductors b1 to b5. The inner conductors 13a to 13f are made of a conductive material mainly containing, for example, Ag. Alphabet characters are appended to the reference numerals when the inner conductors 13a to 13f are individually specified, and the alphabet characters are omitted from the reference numerals when the inner conductors 13a to 13f are collectively indicated hereinafter.

The inner conductors (coil conductors) 13b to 13e are coil conductors provided on the main faces at the positive side in the z-axis direction of the magnetic layers 12e to 12h, respectively. The inner conductors 13b to 13e are composed of coil parts 14b to 14e and connection parts 18b to 18e and 20b to 20e, respectively. The inner conductors 13b and 13d have the same shape and the inner conductors 13c and 13e have the same shape.

The coil parts 14b to 14e are linear electrodes each having a length of substantially one turn and a rectangular shape. The connection part 18b connects the point A on the magnetic layer 12e with one end of the coil part 14b. The connection part 18c connects the point A on the magnetic layer 12f with one end of the coil part 14c. The connection part 18d connects the point A on the magnetic layer 12g with one end of the coil part 14d. The connection part 18e connects the point A on the magnetic layer 12h with one end of the coil part 14e.

The connection part 20b connects the point B on the magnetic layer 12e with the other end of the coil part 14b. The connection part 20c connects the point B on the magnetic layer 12f with the other end of the coil part 14c. The connection part 20d connects the point B on the magnetic layer 12g with the other end of the coil part 14d. The connection part 20e connects the point B on the magnetic layer 12h with the other end of the coil part 14e.

Specifically, the connection parts 18b and 18d are connected to the downstream ends of the coil parts 14b and 14d, respectively, in the clockwise direction in a plan view from the positive side in the z-axis direction.

The connection parts 18c and 18e are connected to the upstream ends of the coil parts 14c and 14e, respectively, in the clockwise direction in a plan view from the positive side in the z-axis direction.

The connection parts 20b and 20d are connected to the upstream ends of the coil parts 14b and 14d, respectively, in the clockwise direction in a plan view from the positive side in the z-axis direction.

The connection parts 20c and 20e are connected to the downstream ends of the coil parts 14c and 14e, respectively, in the clockwise direction in a plan view from the positive side in the z-axis direction. Accordingly, the inner conductors 13b and 13d circle clockwise from the point B to the point A in a plan view from the positive side in the z-axis direction. The inner conductors 13c and 13e circle clockwise from the point A to the point B in a plan view from the positive side in the z-axis direction.

The inner conductor 13a is a linear conductor provided on the main face at the positive side in the z-axis direction of the magnetic layer 12d. The inner conductor 13a includes a coil part 14a and an extension 16a. The coil part 14a has a rectangular shape with a partial deficit in a plan view from the positive side in the z-axis direction and circles counterclockwise from the point B. The extension 16a is connected to the end of the coil part 14a, opposite to the point B, and extends to the side face toward the positive side in the x-axis direction of the multilayer body 11a. The inner conductor 13a is electrically connected to the outer electrode 15a with the extension 16a.

The inner conductor (end conductor) 13f is a linear conductor provided on the main face at the positive side in the z-axis direction of the magnetic layer 12i. The inner conductor 13f is over the points A and B in a plan view from the z-axis direction and is electrically connected to the outer electrode 15b.

More specifically, the inner conductor 13f includes a coil part 14f, an extension 16f, and connection parts 18f and 20f. The coil part 14f has a rectangular shape with a partial deficit in a plan view from the z-axis direction. The extension 16f is connected to one end of the coil part 14f and extends to the side face toward the negative side in the x-axis direction of the multilayer body 11a. Specifically, the extension 16f is connected to the downstream-side end in the clockwise direction of the coil part 14f in a plan view from the positive side in the z-axis direction. The inner conductor 13f is electrically connected to the outer electrode 15b with the extension 16f.

The connection part 18f connects the point A on the magnetic layer 12i with the other end of the coil part 14f, and the connection part 20f connects the point B on the magnetic layer 12i with the other end of the coil part 14f. Specifically, the connection parts 18f and 20f are connected to the upstream-side ends in the clockwise direction of the coil part 14f in a plan view from the positive side in the z-axis direction. The inner conductor 13f branches into two at the one end in the above manner and, thus, the inner conductor 13f is over the points A and B in a plan view from the z-axis direction.

The via-hole conductor b1 electrically connects the inner conductor 13a with the inner conductor 13b, the via-hole conductor b2 electrically connects the inner conductor 13b with the inner conductor 13c, the via-hole conductor b3 electrically connects the inner conductor 13c with the inner conductor 13d, the via-hole conductor b4 electrically connects the inner conductor 13d with the inner conductor 13e, and the via-hole conductor b5 electrically connects the inner conductor 13e with the inner conductor 13f, thereby constituting the spiral coil L.

The via-hole conductor b1 is provided so as to penetrate through the magnetic layer 12d having the inner conductor 13a provided thereon and is connected to the point B of the inner conductor 13a.

The via-hole conductor b2 is provided so as to penetrate through the magnetic layer 12e having the inner conductor 13b provided thereon and is connected to the point A of the inner conductor 13b.

The via-hole conductor b3 is provided so as to penetrate through the magnetic layer 12f having the inner conductor 13c provided thereon and is connected to the point B of the inner conductor 13c.

The via-hole conductor b4 is provided so as to penetrate through the magnetic layer 12g having the inner conductor 13d provided thereon and is connected to the point A of the inner conductor 13d.

The via-hole conductor b5 is provided so as to penetrate through the magnetic layer 12h having the inner conductor 13e provided thereon and is connected to the point B of the inner conductor 13e.

The inner conductors 13b and 13d and the via-hole conductors b2 and b4, and the inner conductors 13c and 13e and the via-hole conductors b3 and b5 are alternately arranged in the z-axis direction in a state in which the inner conductors 13b and 13d are electrically connected to the via-hole conductors b2 and b4, respectively. The inner conductors 13c and 13e are electrically connected to the via-hole conductors b3 and b5, respectively.

Specifically, the inner conductor 13b is connected with the inner conductor 13c at the point A via the via-hole conductor b2. The inner conductor 13c is connected with the inner conductor 13d at the point B via the via-hole conductor b3. The inner conductor 13d is connected with the inner conductor 13e at the point A via the via-hole conductor b4.

The inner conductor 13a is provided toward the positive side in the z-axis direction, compared with the inner conductors 13b to 13d. The inner conductor 13a is connected with the inner conductor 13b at the point B via the via-hole conductor b1.

The inner conductor 13f is provided toward the negative side in the z-axis direction, compared with the inner conductors 13b to 13d. The inner conductor 13f is connected with the inner conductor 13e at the point B via the via-hole conductor b5.

### Method of Manufacturing Multilayer Inductor

A method of manufacturing the multilayer inductor 10a will now be described with reference to FIG. 1 and FIG. 2.

A raw material containing a certain amount of ferric oxide (Fe₂O₃), a certain amount of zinc oxide (ZnO), a certain amount of nickel oxide (NiO) and a certain amount of copper oxide (CuO) is subjected to wet mixing in a ball mill. After the resultant mixture is dried and milled, the resultant powder is calcined at 800° C. for one hour. The resultant calcined powder is subjected to wet milling in a ball mill, dried, and then disintegrated to produce a ferrite ceramic powder.

A binder (for example, vinyl acetate or water-soluble acryl), a plasticizer, a humectant and a dispersant are added to the ferrite ceramic powder to conduct mixing in a ball mill. The resultant mixture is defoamed by depressurization. The resultant ceramic slurry is formed into a sheet shape on a carrier sheet by a doctor blade method and is dried to produce a ceramic green sheet to be used as the magnetic layer 12.

Next, the via-hole conductors b1 to b5 are formed in the respective ceramic green sheets to be used as the magnetic layers 12d to 12h. Specifically, the ceramic green sheets to be used as the magnetic layers 12d to 12h are irradiated with laser beams to form via holes in the ceramic green sheets. The via holes are filled with a conductive paste made of Ag, Pd, Cu, Au or an alloy thereof by, for example, a printing method.

Then, a conductive paste mainly containing Ag, Pd, Cu, Au or an alloy thereof is applied to the ceramic green sheets to be used as the magnetic layers 12d to 12i by screen printing, photolithography or another method to form the inner conductors 13a to 13f. The formation of the inner conductors 13a to 13f and the filling of the via holes with the conductive paste may be performed in the same process.

Then, the ceramic green sheets are laminated. Specifically, the ceramic green sheet to be used as the magnetic layer 12l is disposed. The carrier film of the ceramic green sheet to be used as the magnetic layer 12l is peeled off and the ceramic green sheet to be used as the magnetic layer 12k is disposed. Then, the ceramic green sheet to be used as the magnetic layer 12k is subjected to pressure bonding to the magnetic layer 12l. The pressure bonding is performed under conditions in which a pressure of 100 tons to 120 tons be applied for about three seconds to thirty seconds. The carrier film is suction-discharged or chuck-discharged. Then, the ceramic green sheets to be used as the magnetic layers 12j, 12i, 12h, 12g, 12f, 12e, 12d, 12c, 12b and 12a are similarly laminated in this order and are subjected to the pressure bonding. As a result, a mother multilayer body is formed. Permanent pressure bonding is conducted on the mother multilayer body by using, for example, hydrostatic pressure.

Then, the mother multilayer body is cut into the multilayer body 11a of a certain size by guillotine cut to produce the multilayer body 11a that is not fired. A debinding process and firing are conducted on the unfired multilayer body 11a. The debinding process is conducted, for example, at a temperature of 500° C. for two hours in a low-oxygen atmosphere. The firing is conducted, for example, at a temperature of 800° C. to 900° C. for 2.5 hours.

The multilayer body 11a that is fired is produced by the above processes. The multilayer body 11a is subjected to barrel finishing and chamfering. Then, an electrode paste mainly made of silver is applied to the surface of the multilayer body 11a by, for example, an immersion method and is fired to produce silver electrodes to be used as the outer electrodes 15a and 15b. The firing of the silver electrodes is conducted at a temperature of 800° C. for one hour.

Finally, the surfaces of the silver electrodes are plated with nickel (Ni)/tin (Sn) to produce the external electrodes 15a and 15b. The multilayer inductor 10a shown in FIG. 1 is completed through the processes described above.

Although the multilayer inductor 10a is manufactured by the sequential pressure bonding, the multilayer inductor 10a may be manufactured by another method (for example, printing) other than the sequential pressure bonding.

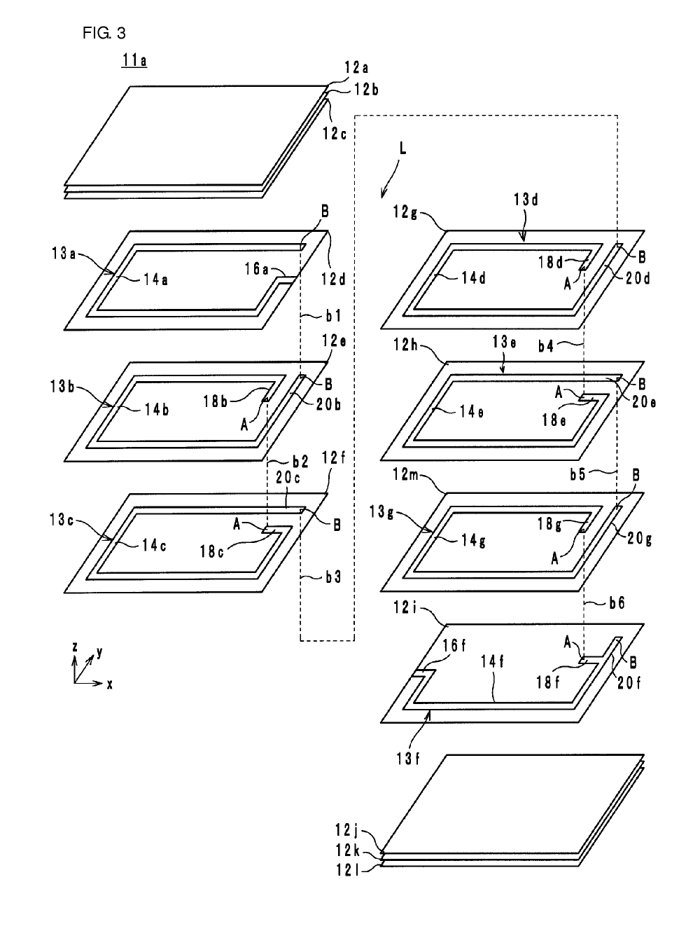

In the multilayer inductor 10a having the above structure, the number of turns of the spiral coil L can be adjusted in units of one turn without preparing multiple kinds of the inner conductors 13f to be positioned at the negative-side end in the z-axis direction, as described below. FIG. 3 is an exploded perspective view of the multilayer body 11a. The number of turns of the spiral coil L in FIG. 3 is larger than that of the spiral coil L in FIG. 2 by one turn.

In order to increase the number of turns of the spiral coil L by one turn in the multilayer inductor 10a shown in FIG. 2, a magnetic layer 12m having an inner conductor 13g of the same shape as that of the inner conductors 13b and 13d provided thereon is placed between the magnetic layer 12h and the magnetic layer 12i, as shown in FIG. 3. In this case, the via-hole conductor b5 is connected to the point B of the inner conductor 13g to connect the inner conductor 13e with the inner conductor 13g. In contrast, the inner conductor 13f is over the points A and B in a plan view from the z-axis direction. Specifically, the inner conductor 13f has the connection parts 18f and 20f connecting the other ends of the coil part 14f with the points A and B, respectively. Accordingly, a via-hole conductor b6 provided in the magnetic layer 12m connects the point A of the inner conductor 13g with the point A of the inner conductor 13f.

With the above structure, in the multilayer inductor 10a, the inner conductor 13 adjacent to the inner conductor 13f can be connected with the inner conductor 13f even when the inner conductor 13 has the same shape as that of the inner conductors 13b, 13d and 13g, or even when the inner conductor 13 has the same shape as that of the inner conductors 13c and 13e. Consequently, according to the multilayer inductor 10a, it is possible to adjust the number of turns of the spiral coil L in units of one turn without preparing multiple kinds of the inner conductors 13f to be positioned at the negative-side end in the z-axis direction.

The connection parts 18f and 20f are linear electrodes in the multilayer inductor 10a, as shown in FIG. 2 and FIG. 3. Accordingly, the connection parts 18f and 20f also compose part of the spiral coil L. As a result, the number of turns of the spiral coil L is increased to increase the inductance of the spiral coil L in the multilayer inductor 10a.

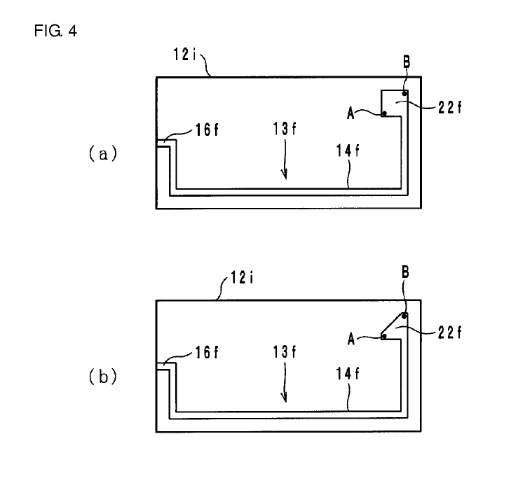

Modifications of the inner conductor 13f will now be described with reference to FIGS. 4(a) and (b). FIG. 4(a) is a plan view of the inner conductor 13f according to a first modification from the positive side in the z-axis direction. FIG. 4(b) is a plan view of the inner conductor 13f according to a second modification from the positive side in the z-axis direction.

It is sufficient for the inner conductor 13f to be over the points A and B in a plan view from the z-axis direction, as described above. Accordingly, the inner conductor 13f does not necessarily have the structure in which one end of the inner conductor 13f branches, as in the structure shown in FIG. 2 and FIG. 3. Specifically, the inner conductor 13f may have a quadrangular connection part 22f having the connection parts 18f and 20f as two sides, as shown in FIG. 4(a). Alternatively, the inner conductor 13f may have a right-angled triangular connection part 22f having the connection parts 18f and 20f as two sides, as shown in FIG. 4(b).

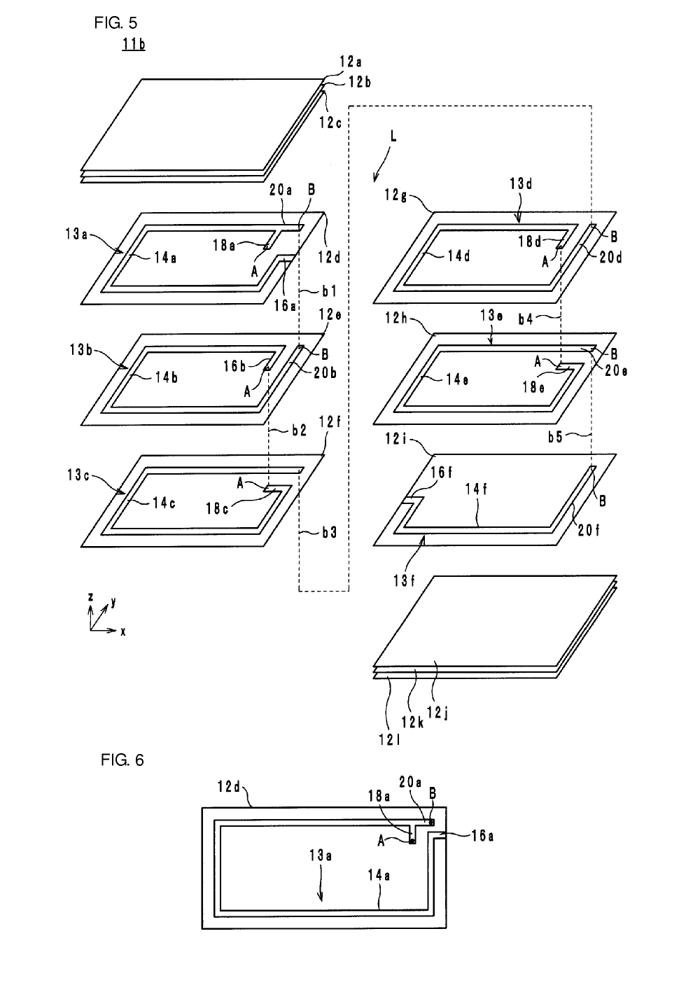

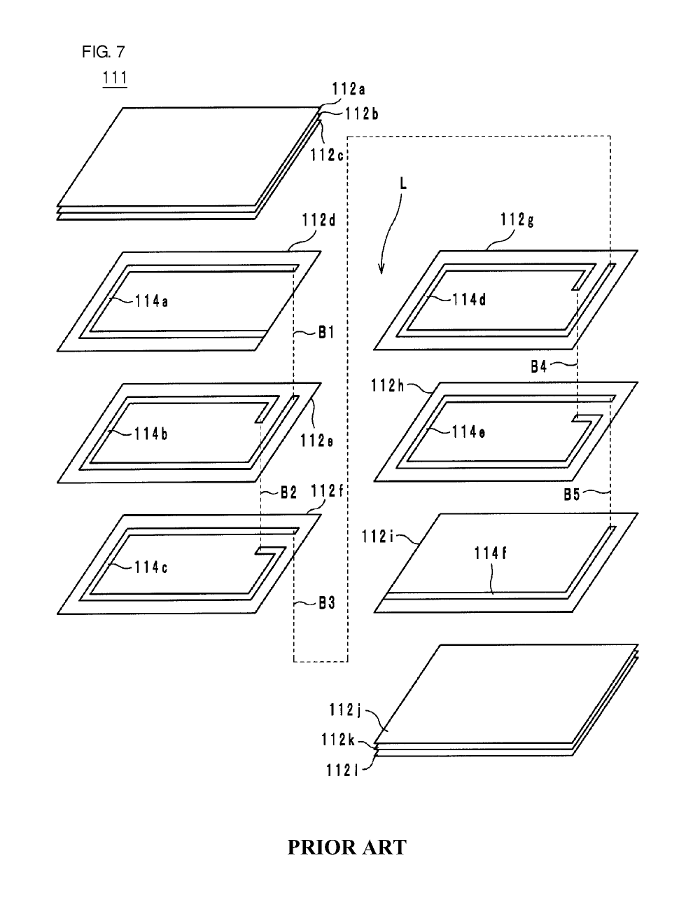

The electronic component according to the present invention is not limited to the multilayer inductor 10a described in the above embodiments and various changes may be made to the invention without departing from the spirit thereof. The multilayer inductors 10b according to other embodiments will now be described with reference to the drawings. FIG. 5 is an exploded perspective view of a multilayer body 11b of the multilayer inductor 10b.

The number of turns of the spiral coil L is adjusted by adding the new inner conductor 13 between the inner conductor 13f positioned at the most negative side in the z-axis direction and the inner conductor 13e in the multilayer inductor 10a.

However, the method of adjusting the number of turns of the spiral coil L is not limited to the above. Specifically, the number of turns of the spiral coil L may be adjusted by adding the new inner conductor 13 between the inner conductor 13a positioned at the most positive side in the z-axis direction and the inner conductor 13b. However, it is necessary to differentiate the shape of the inner conductor 13a from the shape shown in FIG. 2 or FIG. 3 in order to realize such an adjusting method.

More specifically, the inner conductor 13 having the same shape as that of the inner conductors 13b and 13d, or the inner conductor 13 having the same shape as that of the inner conductor 13c and 13e, is adjacent to the inner conductor 13a. Accordingly, it is necessary for the inner conductor 13a to be structured so as to be capable of being connected to both the inner conductor 13 having the same shape as that of the inner conductors 13b and 13d and the inner conductor 13 having the same shape as that of the inner conductor 13c and 13e. Consequently, as shown in FIG. 5, it is sufficient for the inner conductor 13a to be over the points A and B in a plan view form the z-axis direction. However, in the multilayer inductor 10b, although it is not necessary to change the shape of the inner conductor 13a in accordance with the shape of the inner conductor 13 adjacent to the inner conductor 13a, it is necessary to change the position of the via-hole conductor b1. Specifically, the via-hole conductor bl is provided at the point B when the inner conductor 13 adjacent to the inner conductor 13a has the same shape as that of the inner conductors 13b and 13d, while the via-hole conductor b1 is provided at the point A when the inner conductor 13 adjacent to the inner conductor 13b has the same shape as that of the inner conductors 13c and 13e.

Also in the multilayer inductor 10b having the above structure, the number of turns of the spiral coil L can be adjusted in units of one turn without preparing multiple kinds of the inner conductors 13a to be positioned at the positive-side end in the z-axis direction, as in the multilayer inductor 10a.

The inner conductor 13a shown in FIG. 5 may be changed to the inner conductor 13a shown in FIG. 6. FIG. 6 is a plan view of the inner conductor 13a according to a modification from the positive side in the z-axis direction. The extension 16a shown in FIG. 6 is moved toward the positive side in the y-axis direction, compared with the extension 16a shown in FIG. 5, to enter in a quadrangular area having connection parts 18a and 20a as two sides. As a result, the length of the turn of the inner conductor 13a is increased to increase the inductance of the spiral coil L.

The spiral coil L is electrically connected to the outer electrodes 15a and 15b with the extensions 16a and 16f in the multilayer inductors 10a and 10b. However, the method of connecting the spiral coil L with the outer electrodes 15a and 15b is not limited to the above one. For example, when the outer electrodes 15a and 15b are provided on the top face and the bottom face at both ends in the z-axis direction of the multilayer body 11a or 11b, a via-hole conductor penetrating through the magnetic layers 12a to 12c and a via-hole conductor penetrating through the magnetic layers 12i to 12l may be provided, instead of the extensions 16a and 16f in FIG. 2. In this case, the via-hole conductors may connect the spiral coil L with the outer electrodes 15a and 15b.

Although the inner conductor 13 has a rectangular shape or a rectangular shape with a partial deficit in the multilayer inductors 10a and 10b, the shape of the inner conductor 13 is not limited to this. The inner conductor 13 may have, for example, a circular or elliptical shape or a circular or elliptical shape with a partial deficit.

The present invention is useful for an electronic component and, particularly, is excellent in that the number of turns of the coil can be adjusted without preparing multiple kinds of inner conductors to be positioned at an end in the layer direction.

While preferred embodiments of the disclosure have been described above, it is to be understood that variations and modifications will be apparent to those skilled in the art without departing from the scope and spirit of the disclosure.

What is claimed is:

1. An electronic component comprising:
a multilayer body including a plurality of laminated insulating layers;
an outer electrode provided on a surface of the multilayer body; and
a coil formed in the multilayer body,
wherein the coil includes
a first coil conductor that circles in a first direction from a first point to a second point in a plan view from a layer direction;
a second coil conductor that circles in the first direction from the second point to the first point in a plan view from the layer direction;
a first via-hole conductor connected to the first point of the first coil conductor;
a second via-hole conductor connected to the second point of the second coil conductor; and
an end conductor that is over the first point and the second point and that is electrically connected to the outer electrode in a plan view from the layer direction,
wherein the first coil conductor, the first via-hole conductor, the second coil conductor and the second via-hole conductor are alternatively arranged in the layer direction in a state in which the first coil conductor, the first via-hole conductor, the second coil conductor, and the second via-hole conductor are electrically connected to each other, and
wherein the end conductor is provided at an upper side or a lower side of the layer direction, compared with the first coil conductor and the second coil conductor, and is electrically connected to the adjacent first coil conductor or second coil conductor.

2. The electronic component according to claim 1,
wherein the first coil conductor, the second coil conductor, and the end conductor are provided on the main faces at the upper side in the layer direction of the corresponding insulating layers,
wherein the first via-hole conductor is provided in the insulating layer on which the first coil conductor is provided,
wherein the second via-hole conductor is provided in the insulating layer on which the second coil conductor is provided, and
wherein the end conductor is provided at the lower side in the layer direction, compared with the first coil conductor and the second coil conductor.

3. The electronic component according to claim 1,
wherein the end conductor branches into two at one end to be over the first point and the second point in a plan view from the layer direction.

4. The electronic component according to claim 2,
wherein the end conductor branches into two at one end to be over the first point and the second point in a plan view from the layer direction.
